(19) United States
(12) Patent Application Publication
(10) Pub. No.: US 2009/0147296 A1
(43) Pub. Date: Jun. 11, 2009

(54) COLLECTING RESOURCE USAGE INFORMATION IN A PRINT SHOP

(75) Inventors: Rakesh Pandit, Irvine, CA (US); Geoff W. Harmon, Mission Viejo, CA (US)

Correspondence Address: YING CHEN;Chen Yoshimura LLP, 255 S. GRAND AVE., # 215, LOS ANGELES, CA, 90012, US

(73) Assignee: KONICA MINOLTA SYSTEMS LABORATORY, INC., Huntington Beach, CA (US)

(21) Appl. No.: 11/953,040

(22) Filed: Dec. 8, 2007

(51) Int. Cl. G06K 15/00

(52) U.S. Cl. 358/1.15

(57) ABSTRACT

A method used in a print shop for collecting and tracking the amount of resources used for a print job is described. The print shop includes a plurality of copy production devices such as printers and finishing devices and a server for managing them. Each copy production device collects information regarding actual resource usage for a copy production job, such as the amount of paper used, the amount of toner used, the number of staples used, etc., and provides the information to the server after the job is executed. The server generates total resource usage information for executing the job, and stores the information. The actual perjob resource usage information may be analyzed to enable the print shop to set a price structure that more accurately reflects and ultimately recaptures the cost incurred.

### BACKGROUND OF THE INVENTION

1. Field of the Invention

This invention relates to a print shop management system and method, and in particular, it relates to a method for automatically collecting resource usage information for print jobs.

2. Description of Related Art

In an environment that processes a large number of print jobs with multiple printers and other copy production devices, there is a need to manage print jobs efficiently in an organized fashion. Examples of such an environment are professional print shops and print/copy departments at large organizations, where a variety of print requests—such as large-volume duplication and large document printing—need to be processed and completed by utilizing multiple printers and other devices within a short turn-around time. These environments are collectively referred to as “print shops” in this patent application. Typically, each printing job contains a document to be printed and an electronic job ticket, a data-file that specifies the size, color and the type of the paper on which the document should be printed, as well as layout components like duplex or single-side printing, and finishing settings such as booklet, staple, folding, etc., depending on a print job requester's needs. In order to process a large volume of print jobs that each differ in terms of these job parameters, a print shop utilizes multiple commercial grade copy production devices including printers, finishing devices, etc.

Generally, when a customer of a print shop orders a print job, the customer is given a price for the job based on an estimate of what the job will cost. This estimate is based upon an internal cost model and may include many different components including man-hours, overhead costs and cost of physical resources. As an individual job prints, it consumes an actual amount of resources, e.g., sheets of paper (including jams), toner, staples, etc. Additionally, specific trays are used as are punch units. Trays and punch units may be amortized by a shop, meaning that each time a tray or punch unit is used, that occurrence can be assigned a monetary value.

### SUMMARY

By tracking the physical resources usage and manpower usage, the actual cost of various pricing components can be quantified on a per job basis. This information may then be used and compared to the amount the customer was charged for physical resources. Comparing these values over time will allow the print shop to create more accurate pricing models.

Accordingly, the present invention is directed to a method and apparatus useful in a print shop for collecting actual resource usage information for printing a job.

An object of the present invention is to automatically collect the actual cost of resource consumptions on a per job basis.

Additional features and advantages of the invention will be set forth in the descriptions that follow and in part will be apparent from the description, or may be learned by practice of the invention. The objectives and other advantages of the invention will be realized and attained by the structure particularly pointed out in the written description and claims thereof as well as the appended drawings.

To achieve these and/or other objects, as embodied and broadly described, the present invention provides a method used in a print shop for collecting and managing resource usage information, the print shop including a print shop management apparatus and a plurality of copy production devices connected thereto, the method including: (a) the print shop management apparatus sending instructions for a copy production job to one or more copy production devices; (b) each copy production device executing the copy production job; (c) each copy production device collecting resource usage information representing resources used by the copy production device for executing the copy production job; (d) each copy production devices sending the resource usage information to the print shop management apparatus; and (e) the print shop management apparatus generating total resource usage information representing total resources used for executing the copy production job.

In another aspect, the present invention provides a computer program product comprising a computer usable medium having a computer readable code embodied therein for controlling a data processing apparatus, the computer readable program code configured to cause the data processing apparatus to execute a process for managing a print shop system, the print shop system including a plurality of copy production devices connected to the data processing apparatus, the process including the steps of: sending instructions for a copy production job to one or more copy production devices; receiving from each copy production devices resource usage information representing resources used by the copy production device for executing the copy production job; and generating total resource usage information representing total resources used for executing the copy production job.

In another aspect, the present invention provides a computer program product comprising a computer usable medium having a computer readable code embodied therein for controlling a copy production device in a print shop, the print shop system including a plurality of copy production devices connected to a print shop management apparatus, the computer readable program code configured to cause the copy production device to execute a process including the steps of: receiving instructions for a copy production job from the print shop management apparatus; executing the copy production job; collecting resource usage information representing resources used by the copy production device for executing the copy production job; and sending the resource usage information to the print shop management apparatus.

It is to be understood that both the foregoing general description and the following detailed description are exemplary and explanatory and are intended to provide further explanation of the invention as claimed.

### BRIEF DESCRIPTION OF THE DRAWINGS

FIG. 1 illustrates a print shop system in which methods according to embodiments of the present invention may be implemented.

FIG. 2 is a flow chart illustrating a method for collecting resource usage information according to an embodiment of the present invention.

### DETAILED DESCRIPTION OF PREFERRED EMBODIMENTS

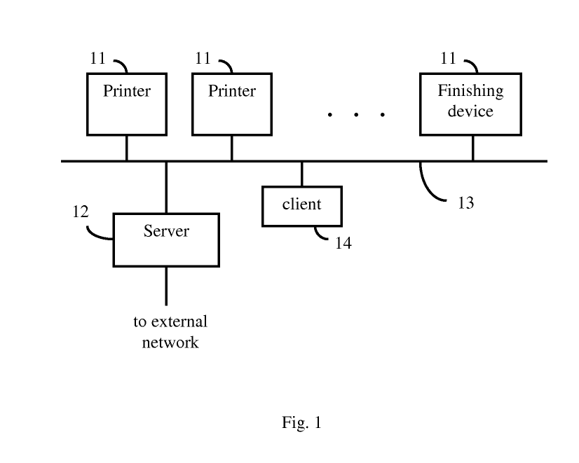

Embodiments of the present invention provide a method and apparatus useful in a print shop for collecting resource usage information in connection with performing customer print jobs. FIG. 1 schematically shows a print shop system having a plurality of copy production devices 11 such as printers, copiers, scanners, finishing devices or the like, connected to a server 12 via a network 13. Here, the server may be any type of data processing apparatus, such as a personal computer, a workstation, and so on. One or more client computers 14 may also be connected to the server to enable print shop operators to interact with the server and the rest of the system. The server 12 is preferably also connected to an external network such as the Internet for receiving print jobs (i.e. print requests from customers and documents to be printed). The server 12, under the control of print shop management software, receives print jobs from customers and submits print commands and data to be printed to one or more devices 11. The print shop management software is preferably stored in a storage medium, such as an HD (Hard Disk) and a CPU (Central Processing Unit) of the server reads out the software to a RAM (Random Access Memory) of the server 12 to execute the same. The server 12 executing the print shop management software is referred to as the print shop management apparatus in this disclosure. Each copy production device 11 includes hardware for making or processing document copies, such as a print engine, stapler, hole puncher, etc. Each copy production device 11 further includes a controller for controlling the various functions of the device. The controller may be a processor executing software or firmware stored in a storage medium on the copy production device.

According to embodiments of the present invention, as a job is executed by one or more copy production devices (printers, finishing devices, etc.), the copy production devices track the usage of various resources for the job. The resource usage information is fed back to the print shop management software via the copy production devices'controller. The resource usage information collected by the copy production devices may include one or more of the following items, which may be grouped into several categories:
Category 1: Actual resource usage per job
   a. Quantity of paper used
   b. Amount of toner
   c. Staples
   d. Punch holes
   e. Folding
   f. Binding materials
Category 2: Actual process time per job
   a. Setup time
   b. In progress time
   c. Stopped time
Category 3. Labor time
   a. Operator name
   b. Start and end time

The above list is intended to provide examples of resource usage information and is not limiting in any way. The actual resource usage information in Category 1 and the actual process time information in Category 2 are obtained from each copy production device such as printer and finishing device used to execute the job. The labor time information in Category 3 is obtained from the print shop management software which tracks logon information. In other words, the copy production devices as well as the print shop management software support collection, processing and presentation of resource usage information.

Details of some of the above-listed items according to a preferred embodiment are explained below. To obtain the paper usage information, when the print job is completed, the printer collects the number of pages processed in each paper tray and the paper attributions of each tray (Paper Size, Paper Weight, Paper Color, etc.) and sends them to the print shop management software. The amount of toner used per job is calculated by the printer based on the assumption that a 6% print rate is equivalent of 18 mg of toner used per page. The toner usage is calculated by using the following formula:

(Toner used per job in mg)=(print area per job)/(A4 area)*(18/6)*100*100

The “staple” counter field represents the number of times by which staple is performed. When two-position staple is executed, this counter increases two counts for each time stapling is performed. The “punch holes” counter field represents the number of times by which punch is performed. This counter does not have any relation to number of holes per punch. The “folding” counter field represents the number of times by which fold is performed. The target of this counter is only single folding and does not count multi page folding. The “setup time” in Category 2 includes a job accepted date and time field, which represents an accepted time of print job from the print management software. The “in progress time” includes a print started date & time field, which represents a started time of print job on print engine, and a job closed date & time field, which represents a closed time of print job on engine. The “stopped time” fields include a jam stopped time field, which represents a stopped time due to jam on a print job; a NoPaper stopped time field, which represents a stopped time due to a “no paper” condition on a print job; a NoToner stopped time field, which represents a stopped time due to a “no toner” condition on a print job; and another stopped time field which represents a stopped time due to other cause on a print job. The operator name and start and end time in Category 3 are tracked by the server when the user (operator) logs on to the print shop management software and processes the job.

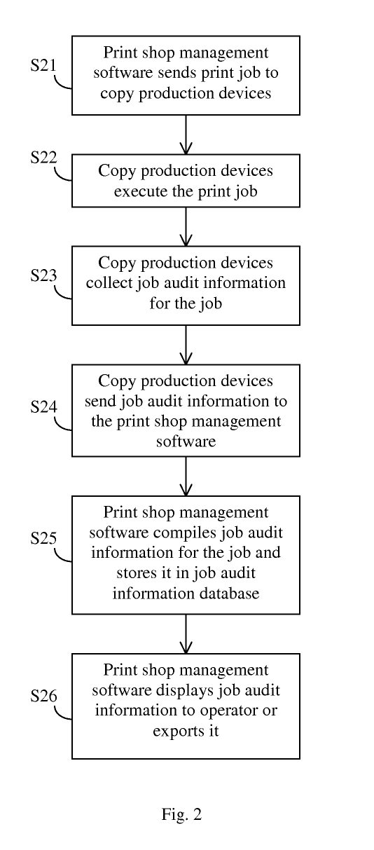

A resource usage information collection method according to an embodiment of the present invention is described with reference to FIG. 2. First, the print shop management software generates a job ticket and sends it to one or more copy production devices for execution (step S21). A job ticket is an instruction that includes a collection of parameters describing a customer's print job, such as the number of copies, orientation, the paper to be used, input tray, output tray, finishing instructions, etc. Job tickets are typically created by a print shop operator or by the print shop management software automatically. Each job ticket sent for execution is preferably accompanied by a job ID. The copy production devices execute various steps required for the job, such as printing, finishing, etc. (step S22). For each execution step, the copy production device used for that step collects information regarding actual resources used for that step (step S23). After the job is completed, the copy production devices send the completed job information, including the resource usage information, back to the print shop management software (step S24). The print shop management software compiles the resource usage information received from the copy production devices to generate total resource usage information for the job, and stores it in a resource usage information database (step S25). The stored information is preferable associated with the job ID. In one example, the print shop management software modifies the original job ticket by adding the resource usage information to the job ticket, and stores it in the database.

The print shop management software may use the resource usage information in various ways as desired. For example, the print shop management software may display the resource usage information to an operator (step S26). The print shop management software may display aggregate resource usage information for a number of jobs, display the resource usage information for an individual job (e.g. by displaying the modified job ticket that includes the resource usage information), or display the resource usage information for a plurality of jobs for comparison purpose. The operator may print the information or export it to another application where it can be compiled, stored and analyzed. The resource usage information for an individual job may be compared to the amount the customer was charged for that job. The information may also be passed to the customer.

In the above descriptions, print jobs are used as examples of customer jobs. Customer jobs may also be copy jobs. More generally, a customer job is a request for producing a specified number of copies of a document, either from digital data (print) or from an original hard copy (copy). The method describe above applies to both print and copy jobs (more generally, copy production jobs). Also, the term “print shop” should be understood to broadly include any establishment that handles production requests, such as commercial print shops, copy production centers within organizations, etc. The term “customer” should be understood to include any person or entity submitting a copy production request to the print shop.

Further, an offline finishing apparatus, such as a bookbinding apparatus, and a paper inserting apparatus, a stapling apparatus, etc., may be used to complete the print job. Since the offline finishing apparatus is physically separated from the copy production apparatuses; the job ticket may be sent from the print management software to the offline finishing apparatus as well, and the offline finishing apparatus may send resource usage information generated in the offline finishing apparatus back to the print job management software. In this case, one of the copy production devices in each step of FIG. 2 may be read as an offline fishing apparatus.

It will be apparent to those skilled in the art that various modification and variations can be made in the resource usage information collection method of the present invention without departing from the spirit or scope of the invention. Thus, it is intended that the present invention cover modifications and variations that come within the scope of the appended claims and their equivalents.

What is claimed is:

1. A method used in a print shop for collecting and managing resource usage information, the print shop including a print shop management apparatus and a plurality of copy production devices connected thereto, the method comprising:
(a) the print shop management apparatus sending instructions for a copy production job to one or more copy production devices;
(b) each copy production device executing the copy production job;
(c) each copy production device collecting resource usage information representing resources used by the copy production device for executing the copy production job;
(d) each copy production device sending the resource usage information to the print shop management apparatus; and
(e) the print shop management apparatus generating total resource usage information representing total resources used for executing the copy production job.

2. The method of claim 1, wherein the resource usage information includes usage of one or more of paper, toner, staples, hole punches, folding, binding materials, and wherein the resource usage information further include a setup time, an in-progress time, and a stopped time on the copy production devices.

3. The method of claim 1, further comprising:
the print shop management apparatus collecting labor time usage information for executing the copy production job.

4. The method of claim 1, wherein step (a) includes generating a job ticket which describes the copy production job, and wherein step (e) includes modifying the job ticket to add the resource usage information.

5. The method of claim 1, further comprising:
the print shop management apparatus displaying the total resource usage information to an operator.

6. The method of claim 1, further comprising:
the print shop management apparatus storing the total resource usage information in a database.

7. A computer program product comprising a computer usable medium having a computer readable code embodied therein for controlling a data processing apparatus, the computer readable program code configured to cause the data processing apparatus to execute a process for managing a print shop system, the print shop system including a plurality of copy production devices connected to the data processing apparatus, the process comprising the steps of:
sending instructions for a copy production job to one or more copy production devices;
receiving from each copy production device resource usage information representing resources used by the copy production device for executing the copy production job; and
generating total resource usage information representing total resources used for executing the copy production job.

8. The computer program product of claim 7, wherein the resource usage information includes usage of one or more of paper, toner, staples, hole punches, folding, binding materials, and wherein the resource usage information further include a setup time, an in progress time, and a stopped time on the copy production devices.

9. The computer program product of claim 7, wherein the process further comprises:
collecting labor time usage information for executing the copy production job.

10. The computer program product of claim 1, wherein step (a) includes generating a job ticket which describes the copy production job, and wherein step (e) includes modifying the job ticket to add the resource usage information.

11. The computer program product of claim 7, wherein the process further comprises:
displaying the total resource usage information to an operator.

12. The computer program product of claim 7, wherein the process further comprises:
storing the total resource usage information in a database.

13. A computer program product comprising a computer usable medium having a computer readable code embodied therein for controlling a copy production device in a print shop, the print shop system including a plurality of copy production devices connected to a print shop management apparatus, the computer readable program code configured to cause the copy production device to execute a process comprising the steps of:
receiving instructions for a copy production job from the print shop management apparatus;
executing the copy production job;
collecting resource usage information representing resources used by the copy production device for executing the copy production job; and
sending the resource usage information to the print shop management apparatus.

14. The computer program product of claim 13, wherein the resource usage information includes usage of one or more of paper, toner, staples, hole punches, folding, binding materials, and wherein the resource usage information further include a setup time, an in progress time, and a stopped time on the copy production device.
